(19) United States
(12) Patent Application Publication
(10) Pub. No.: US 2025/0273698 A1
(43) Pub. Date: Aug. 28, 2025

(54) FLOW FIELD PLATE FOR A FUEL CELL

(71) Applicants: CELLCENTRIC GMBH & CO. KG, Kirchheim/Teck-Nabern (DE); SCHUNK KOHLENSTOFFTECHNIK GMBH, Heuchelheim (DE)

(72) Inventors: Philipp HAUSMANN, Kirchheim/Teck-Nabern (DE); Jürgen WALDSCHMIDT, Biebertal (DE); Dominik WITTKA, Bischoffen (DE); Hauke VOORMANN, Linden (DE); Günter RINN, Lahnau (DE)

(21) Appl. No.: 18/570,985

(22) PCT Filed: Jul. 20, 2022
(86) PCT No.: PCT/EP2022/070298

§ 371 Date: Apr. 8, 2024

(30) Foreign Application Priority Data
Jul. 22, 2021 (DE) 10 2021 207 840.0

(51) Int. Cl. H01M 8/0213; H01M 8/0258

(52) U.S. Cl. CPC H01M 8/0213; H01M 8/0258

(57) ABSTRACT

The invention relates to a bipolar plate for a fuel cell made of two plate halves with mutually facing surfaces and aligning elements in the region of said surfaces, which have elevations with a height and corresponding depressions with a depth. The invention is characterized in that all of the elevations and corresponding depressions have a greater extension in the longitudinal direction than in the transversal direction, wherein four of the corresponding parts of the aligning elements are arranged on each of the surfaces, two respective parts of the parts lying on a common straight line and having the same orientation.

The invention relates to a bipolar plate for a fuel cell made of two plate halves, which are in particular glued together, of the type defined in more detail in the preamble of claim 1.

Such a bipolar plate is known in principle from DE 10 2009 036 039 A1. In this case, the bipolar plate consists of two halves or layers which are joined to together in a materially bonded manner, for example by welding, in the case of metallic bipolar plates, as described in the aforementioned German publication.

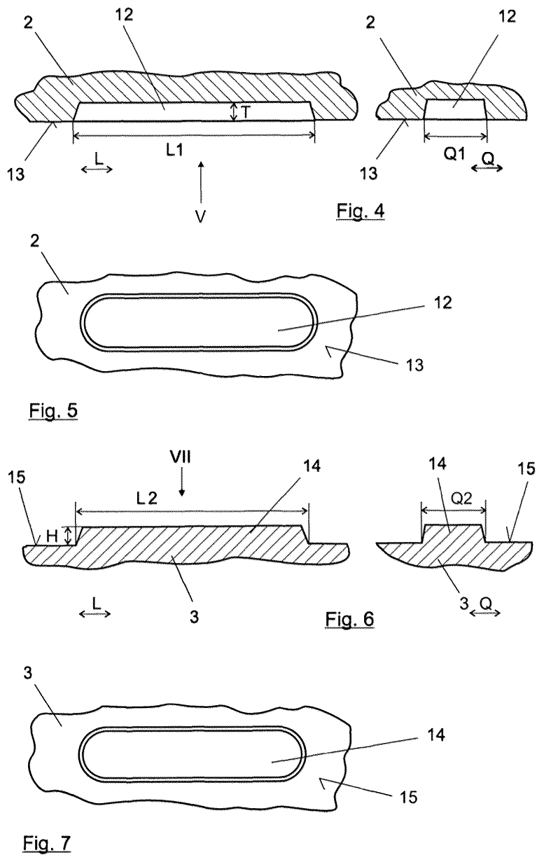

In order to be able to align the two plate halves or layers against each other as efficiently as possible, aligning elements are provided on the mutually facing surfaces of the plate halves. These consist of an elevation with a height and a corresponding depression with a depth. When the two plate halves or layers are positioned on top of each other, the elevations engage the depressions and thus help to align the components with each other. In the aforementioned German publication, this is described correspondingly in the exemplary embodiments starting from FIG. 4. Here, the structure is such that in the one direction positioning takes place via one element and in the other direction positioning takes place via two elements. For this purpose, the depression in one of the plates is significantly larger than the elevation in the other plate, which also has a shape that differs from the depression. This is comparatively complex. Moreover, the elements for alignment are provided adjacent to the actual flow field and detrimentally influence the shape of the bipolar plate or, in the event that they have to be subsequently separated, cause considerable additional manufacturing expense.

The object of the present invention is therefore to provide an improved bipolar plate comprising two plate halves of the type defined in more detail in the preamble of claim 1.

According to the invention, this object is achieved by a bipolar plate having the features of claim 1, and in particular of the characterizing part of claim 1. Advantageous embodiments and developments of this bipolar plate result from the corresponding dependent claims.

The bipolar plate according to the invention is provided in two halves, as in the generic prior art. The two plate halves have, at least on their mutually facing surfaces aligning elements in the region of the surface, which consist of elevations having a height and corresponding depressions having a depth. According to the invention, all of the elevations and corresponding depressions have a greater extension in a first longitudinal direction than in a second transverse direction, the longitudinal direction and the transverse direction being perpendicular to each other and lying in the same plane. Four of the aligning elements are now disposed on each of the surfaces. In each case, two of the aligning elements lie on a common straight line and have the same orientation. This means, therefore, that the longitudinal direction of the two aligning elements lying on a common straight line is oriented the same with respect to, for example, the outer edge of the plate half or a central line of symmetry of the plate half, while the other two aligning elements lying on a second straight line preferably intersecting the first straight line also have this same orientation. The orientations are thus the same in pairs, but preferably different between the pairs. This enables correspondingly simple and efficient positioning of the two plate halves, which can then simply form-fit connected—in particular glued—to one another. This gluing can preferably be effected by means of a sealing and adhesive compound inserted into or applied to one of the plate halves.

According to a very advantageous development of the bipolar plate according to the invention, it is thereby provided that the longitudinal direction of the two aligning elements extends with the same orientation along the straight line. The longitudinal direction is thus arranged along or in alignment with the straight line connecting the two respective aligning elements, so that an adjustment of the position along this straight line and along the longitudinal direction is still possible to a certain extent, which results from the unavoidable minimal difference in size between the depression on the one hand and the corresponding elevation on the other hand, which in practice, however, is very small, since only tolerances in the range of a few tenths of a millimeter have to be compensated.

According to a further very advantageous embodiment of the bipolar plate according to the invention, at least one of the straight lines does not coincide with a line of symmetry between the outer dimensions of the plate half. In principle, two of the aligning elements could be positioned on one and the same straight line centered in the corresponding plate half. However, it has been found advantageous if the straight line runs off-center and deviates from such a line of symmetry in the center of the structure. In particular, it can run obliquely thereto so that the aligning elements with the same orientation are arranged, for example, in diagonally opposite corners of the respective plate half.

According to a further very favorable embodiment, however, it may also be provided that the straight line deviating from the line of symmetry is oriented parallel thereto and deviates from this line of symmetry by less than twice the dimension of the longitudinal direction parallel thereto. Thus, in this particularly favorable embodiment, the straight line is only “slightly” offset from the line of symmetry to efficiently counteract potential twisting of the plate halves relative to each other prior to alignment and gluing. This makes the manufacturing process very resistant to errors.

A further very advantageous embodiment of the bipolar plate according to the invention may now further provide that the elevations and corresponding depressions have the same shaping, wherein the elevations are smaller in the longitudinal direction, the transverse direction as well as in their height than the depressions in the longitudinal direction, the transverse direction and their depth. The same shaping and the only minimally smaller design of the elevations in all three spatial directions compared to the depressions allows the respective elevation to be efficiently accommodated by the respective depression in order to achieve a safe and reliable alignment, which allows the two plate halves to be aligned with very low tolerances to each other and at the same time efficiently compensates for the minimal manufacturing tolerances in the plates.

According to an advantageous embodiment of the bipolar plate according to the invention, the plate halves are thereby formed from a plastic matrix with carbon-containing material distributed therein. Such bipolar plates, which are often also referred to as graphite plates or carbon composite bipolar plates, are typically manufactured in corresponding molds. They are thus subject to comparatively low manufacturing tolerances, since the mold allows a forced shaping with low tolerances. The same shaping of the elevations and the corresponding depressions can thus be ideally used to join these types of plates together in an optimal manner. This is unlike, for example, the metallic bipolar plates described in the cited prior art, which expand accordingly during welding, and therefore make virtually impossible the provision of the same shape for elevations and corresponding depressions.

A further very advantageous embodiment further provides that the surfaces of the elevations extending transversely to the surface are arranged at the same angle to the surface as the corresponding surfaces of the depressions. It is thus particularly advantageous if, within the aligning elements, both the elevations and the depressions have the same angle in their region extending transversely to the surface. This angle can be, for example, about 5 to 15° and thus permits reliable mutual insertion of the two plate halves into one another in the region of their aligning elements with simultaneous alignment of the position of the one plate half relative to the other plate half in order to glue the two plate halves.

According to a very advantageous embodiment, the extension of the aligning elements in the transverse direction can thereby be less than one third of the extension in the longitudinal direction, so as to reliably define a specific preferential direction, wherein the height and depth are less than half of the extension in the transverse direction. This reliably prevents the elevations from resting on the bottom of the depressions, so that the contact and sealing are achieved by gluing between the actual plate halves and their surfaces in the regions provided for this purpose.

The longitudinal direction in this case can have an extension of, for example, 2 to 10 mm, preferably 5 to 7 mm, in the case of a conventional bipolar plate. Such a structure is small enough to be placed between the flow-guiding regions and the outer edge of the plate half and is at the same time large enough to allow reliable mutual positioning of the plate halves to each other. Unlike in the prior art mentioned at the outset, no additional elements such as projections or ears are then necessary to position the elements accordingly for alignment, which elements would then take up unnecessary space in later use and entail unnecessary weight or have to be removed from the finished bipolar plates with corresponding effort.

Further advantageous embodiments of the bipolar plate according to the invention also result from the exemplary embodiments, which are described in more detail in the following with reference to the figures.

In particular:

FIG. 1 shows a schematic exploded view of a bipolar plate according to the prior art;

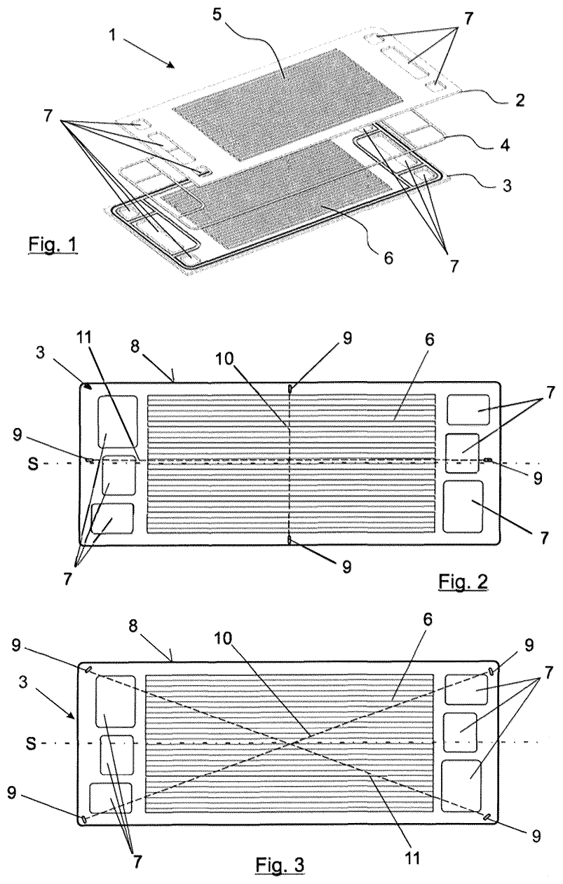

FIG. 2 shows a top view of a first possible embodiment of a plate half of a bipolar plate according to the invention;

FIG. 3 shows a top view of a second possible embodiment of a plate half of a bipolar plate according to the invention;

FIG. 4 shows a longitudinal section and a cross-section through a depression of the aligning element;

FIG. 5 shows a top view of the depression according to FIG. 4;

FIG. 6 shows a cross-section and a longitudinal section through an elevation of an aligning element according to the invention; and

FIG. 7 shows a top view of the elevation according to FIG. 6;

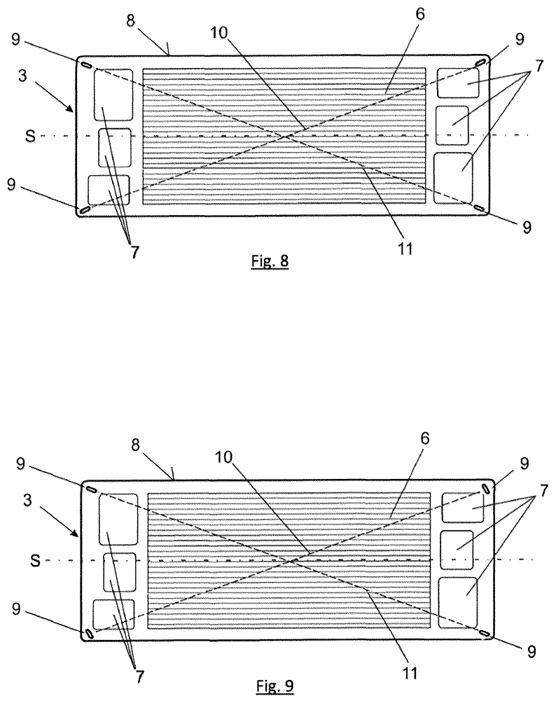

FIG. 8 shows a top view of a third possible embodiment of a plate half of a bipolar plate according to the invention;

FIG. 9 shows a top view of a fourth possible embodiment of a plate half of a bipolar plate according to the invention.

In the illustration of FIG. 1, a schematically indicated bipolar plate 1 is shown in an exploded view. It consists of two plate halves 2, 3, which in the exemplary embodiment shown here are joined together by a sealing and adhesive compound 4. In a manner known per se, a flow field 5 is provided in the surface shown above for one of the reactants of a fuel cell constructed with such bipolar plates 1, in particular atmospheric oxygen or hydrogen. A cooling medium flow field is typically enclosed between the two plate halves 2, 3, of which only one of the halves, namely the lower plate half 3, can be seen. This is designated by the reference sign 6. Otherwise, openings 7 are provided in the bipolar plate 1 for the supply and removal of mediums, which openings are designed in a manner known per se. A detailed illustration is omitted here, since such an illustration is of secondary importance for the present invention and could be designed in any manner familiar to the skilled person. In the illustration of FIG. 2, the lower plate half 3 and its corresponding flow field 6 for the cooling medium is now shown again, as an example. The flow field 6 is located, together with the aforementioned openings 7, within an outer border 8 of the respective plate halves 2, 3 as well as of the later bipolar plate 1 formed by bonding these plate halves 2, 3. Each of the plate halves 2, 3 originates here from a press mold and consists of a mixture of a carbon-containing material, such as graphite, and a corresponding plastic matrix. The finished plate halves 2, 3 are largely identical over an entire stack of the fuel cell. Only in the case of the two bipolar plates 1 in the edge region of the fuel cell, which are also referred to as interface plates, only one of the plate halves 2, 3 is required and combined with an alternative interface plate half, or two adapted plate halves are used. However, the same applies to these elements as to the plate halves 2, 3 of the bipolar plate 1, which are described in detail below.

In order to simplify an alignment of the two plate halves 2, 3 with respect to each other, aligning elements 9 are now provided on the surfaces of the plate halves 2, 3 facing each other, which are each formed by a ridge or elevation 14 (cf. FIG. 6) in one of the plate halves 2, 3 and a corresponding depression 12 (cf. FIG. 4) in the same region of the respective other plate half 3, 2. In the illustration of FIG. 2, two aligning elements 9 are thereby formed approximately centrally with respect to the flow field 6 transversely to the main direction of the channels through which the flow passes. In the exemplary embodiment shown here, they are formed by two rectangles with rounded edges, which are arranged in such a way that they are connected to each other via a straight line marked with 10 in dashed lines. They are located inside the outer perimeter 8 of the plate half 3 and outside the actual flow field 6. Another pair of aligning elements 9 is also located between the outer perimeter 8 and the openings 7 and can be connected to each along another straight line 11. These two pairs of aligning elements 9 are each arranged in the same orientation, which in the exemplary embodiment shown in FIG. 2 is aligned with a longitudinal direction of the respective aligning elements 9, as further explained in the following FIGS. 4 ff., or aligned along the straight line 11 or 10. The straight lines 10, 11 thereby intersect at approximately a right angle, so that the longitudinal directions of the aligning elements 9, which are combined in respective pairs, are also correspondingly at right angles to one another. At least one of the straight lines, in this case the straight line 11, is offset parallel to a line of symmetry S of the plate half 3 in order to reliably prevent an inverted assembly of the plate halves 2, 3. The offset between the line of symmetry S and the straight line 11 is thereby smaller than twice the extension of the aligning elements 9 in the longitudinal direction, namely comparatively small with respect to the size of the entire plate half 3 or bipolar plate 1.

In the illustration of FIG. 3, an alternative arrangement of the individual aligning elements 9 is shown. Here, the straight lines 10 and 11 are each formed to run diagonally from one corner to the other and intersect approximately in the center of the plate half 3. Here, too, the two aligning elements 9 connected to each other via the respective straight line 10 or 11 are again formed with the same orientation in each case, which, however, need not be oriented in alignment with the respective straight line 10, 11, as can be seen in the illustration of FIG. 3. The orientations of the respective pairs of aligning elements 9, which are connected to one another via the respective straight line 10, 11, can, for example, be formed with a larger angle than the intersection angle between the two straight lines 10, 11, so that the orientations lie, for example, in an angle range between 80 and 100° with respect to one another.

In the illustration of FIGS. 4 ff., an enlarged illustration of a possible design of the depressions 12 and elevations 14 of the aligning elements 9 can now be seen. In the representation of FIG. 4, for example, the plate half 2, which in the representation of FIG. 1 corresponds to the upper plate half and purely by way of example to the anode plate, is shown. In the figure on the left, the depression 12 can be seen in longitudinal section along the longitudinal direction L, and in the cross-section along the transverse direction Q next to it on the right. Along the longitudinal direction L, the depression 12 has, for example, in the region which faces the surface 13 of the plate half 2, a first extension L1 in the longitudinal direction L and a first extension Q1 in the transverse direction Q. The depth between the surface 13 and the deepest point of the depression 12 is thereby T.

For example, the extension L1 in the longitudinal direction can be, for example, about 6 mm, while the depth T can be 0.5 mm and the extension in the transverse direction Q can be Q1=1.5 mm. In this case, the depression 12 can have the shape of a rectangle with rounded edges or two semicircles connected by straight edges, as shown in the illustration of FIG. 5 in a viewing direction according to the arrow V in FIG. 4.

In the illustration of FIG. 6, the elevation 14 corresponding to the depression 12 in the illustration of FIG. 4 is now shown, with the longitudinal section on the left and the cross-section on the right also being visible here. The elevation 14 projects correspondingly beyond the surface 15 of the second plate half 3. In the longitudinal direction L, it again has a dimension L2 in the region of the intersection lines with the surface 15, and in the transverse direction Q it has a dimension of Q2. It has a height H relative to the surface 15. The shaping here, as can be seen from FIG. 7 according to the arrow VII in FIG. 6, is comparable to the shaping of the depression 12. However, the dimensions are somewhat smaller, so that L2 is smaller than L1, for example when L1=6 mm, L2=5.8 mm. Q2 is correspondingly smaller than Q1, for example Q1=0.5 mm and Q2=0.135 to 0.145 mm. The height H is also correspondingly smaller than the depth T, in order to achieve centering while not impairing the contact of the surfaces 13, 15 against each other or against the adhesive and sealing compound 4 arranged between them. For this purpose, the depth T can be, for example, 0.5 mm as already mentioned above, while the height H is only 0.45 mm.

It is of course clear to the person skilled in the art that the dimensions mentioned are purely exemplary and can be varied accordingly. In particular, the depth T should be less than one third of the thickness of the entire plate half 2, 3 in order to prevent an unnecessary reduction in the stability of the plate half 2.

FIG. 8 shows a variant of the embodiment according to FIG. 2. The arrangement of the aligning elements 9 according to FIG. 2 could be described as cross-shaped. The arrangement of the aligning elements 9 according to FIG. 8 could analogously also be described as cross-shaped, wherein the cross in FIG. 8 is tilted to the side or has been rotated by 45° compared to FIG. 2.

The embodiment according to FIG. 9 combines design elements of the embodiments according to FIG. 3, in which the arrangement of the aligning elements 9 could be described as circular, and of the embodiment according to FIG. 8: the two aligning elements 9 at the bottom left and top right are arranged as in FIG. 3; the two aligning elements 9 at the top left and bottom right are arranged as in FIG. 9.

Of course, other configurations are possible, such as an inverted arrangement, namely a depression 12 in the plate half 3 and the elevation 14 in the plate half 2. Of course, the positioning of the depression 12 and the corresponding elevation 14 in the respective plate halves 2, 3 can also be changed accordingly for each of the four aligning elements 9 provided. Each pair of aligning elements 9 could thus comprise, for example, one depression 12 and one elevation 14 on the respective plate half 2, 3. A different design of the pairs with respect to each other would also be conceivable.

What is claimed is:

1. A bipolar plate for a fuel cell made of two plate halves with mutually facing surfaces and aligning elements in the region of said surfaces, which have elevations with a height and corresponding depressions with a depth, wherein
all of the elevations and corresponding depressions have a greater extension in the longitudinal direction than in the transversal direction, wherein four of the corresponding parts of the aligning elements are arranged on each of the surfaces, two respective parts of which lying on a common straight line and having the same orientation.

2. The bipolar plate according to claim 1,
the longitudinal direction of the two aligning elements extends with the same orientation along the respective straight line.

3. (canceled)

4. (canceled)

5. The bipolar plate according to claim 1,
wherein
the elevations and depressions have the same shaping, wherein the elevations are smaller in the longitudinal direction, the transverse direction as well as in height than the corresponding dimensions of the depressions.

6. The bipolar plate according to claim 1,
wherein
the surfaces of the elevation extending transversely to the surface extend at the same angle to the surface as the corresponding surfaces of the depression.

7. The bipolar plate according to claim 1,
wherein
the extension in the transversal direction is less than one third of the extension in the longitudinal direction, the height and depth being less than half of the extension in the transversal direction.

8. The bipolar plate according to claim 1,
wherein
the extension in longitudinal direction is 2 to 10 mm, preferably 5 to 7 mm.

9. The bipolar plate according to claim 1,
wherein
the plate halves are formed from a carbon-containing material distributed in a plastic matrix.

10. The bipolar plate according to claim 1,
wherein
the aligning elements are arranged between the flow-guiding region and an outer edge of the respective plate half.

11. The bipolar plate according to claim 2, wherein
the elevations and depressions have the same shaping, wherein the elevations are smaller in the longitudinal direction, the transverse direction as well as in height than the corresponding dimensions of the depressions.

12. The bipolar plate according to claim 2, wherein
the elevations and depressions have the same shaping, wherein the elevations are smaller in the longitudinal direction, the transverse direction as well as in height than the corresponding dimensions of the depressions.

13. The bipolar plate according to claim 3, wherein
the elevations and depressions have the same shaping, wherein the elevations are smaller in the longitudinal direction, the transverse direction as well as in height than the corresponding dimensions of the depressions.

14. The bipolar plate according to claim 4, wherein
the elevations and depressions have the same shaping, wherein the elevations are smaller in the longitudinal direction, the transverse direction as well as in height than the corresponding dimensions of the depressions.

15. The bipolar plate according to claim 2, wherein
the surfaces of the elevation extending transversely to the surface extend at the same angle to the surface as the corresponding surfaces of the depression.

16. The bipolar plate according to claim 3, wherein
the surfaces of the elevation extending transversely to the surface extend at the same angle to the surface as the corresponding surfaces of the depression.

17. The bipolar plate according to claim 4, wherein
the surfaces of the elevation extending transversely to the surface extend at the same angle to the surface as the corresponding surfaces of the depression.

18. The bipolar plate according to claim 5, wherein
the surfaces of the elevation extending transversely to the surface extend at the same angle to the surface as the corresponding surfaces of the depression.

19. The bipolar plate according to claim 2, wherein
the extension in the transversal direction is less than one third of the extension in the longitudinal direction, the height and depth being less than half of the extension in the transversal direction.

20. The bipolar plate according to claim 3, wherein
the extension in the transversal direction is less than one third of the extension in the longitudinal direction, the height and depth being less than half of the extension in the transversal direction.
